(19) United States
(12) Patent Application Publication
(10) Pub. No.: US 2026/0192247 A1
(43) Pub. Date: Jul. 9, 2026

(54) COMPETIVE CAPILLARY PRESSURE IMPREGNATION OF A SOLID SUBSTRATE

(71) Applicant: ExxonMobil Technology and Engineering Company, Spring, TX (US)

(72) Inventors: Andrew R. Konicek, Whitehouse Station, NJ (US); Mohsen S. Yeganeh, Newtown, PA (US); Mark A. King, Maplewood, NJ (US); Arben Jusufi, Belle Mead, NJ (US); Shane Deighton, Easton, PA (US)

(73) Assignee: ExxonMobil Technology and Engineering Company, Spring, TX (US)

(21) Appl. No.: 19/133,571

(22) PCT Filed: Nov. 20, 2023
(86) PCT No.: PCT/US2023/080540

§ 371 Date: May 28, 2025

Related U.S. Application Data
(60) Provisional application No. 63/440,371, filed on Jan. 20, 2023.

(51) Int. Cl. B01D 53/78

(52) U.S. Cl. CPC B01D 53/78

(57) ABSTRACT

The present disclosure relates to a method that includes: providing a liquid reservoir containing a reactive liquid, wherein the liquid reservoir has reservoir features, and wherein the liquid reservoir at the reservoir features has a reservoir capillary pressure (P_{RC}); providing a solid substrate, wherein the solid substrate comprises at least two primary structures that have primary features, and wherein the at least two primary structures have at least one primary space therebetween, and wherein the at least two primary structures have a space capillary pressure (P_{SC}) therebetween; and contacting the solid substrate with the reservoir features of the liquid reservoir, thereby impregnating the solid substrate with the reactive liquid, wherein an impregnation capillary pressure (P_{IC}) is formed by the solid substrate and the reactive liquid, and wherein the reservoir features, the primary features, and the at least one primary space are sized such that P_{SC}<P_{RC}<P_{IC}.

### FIELD

The present disclosure relates to methods and related systems for reactor operation utilizing a solid with infused reactive liquid (SWIRL).

### BACKGROUND

A liquid-infused surface (LIS) is a chemically functionalized, textured solid substrate that is able to trap and immobilize a liquid layer tens of micrometers thick. LIS technology has been used for protective coatings by immobilizing a nonreactive liquid on a surface in order to mitigate corrosion, prevent icing, or reduce friction or drag, for example. The LIS technology has extended to reactive liquids on substrates where the reactive liquid is to be shaped into a high surface area/volume (A/V) ratio structure by immobilization on a textured substrate. The A/V ratio maximizes the interaction of the reactive liquid with the fluid medium said reactive liquid operates on, reducing the need for energy consuming liquids processing steps. For example, removal of carbon dioxide (CO₂) from a gas mixture may utilize an amine-containing fluid immobilized on a textured surface where the gas contacts the amine-containing fluid and the CO₂ absorbs into the amine-containing fluid, thereby reducing the concentration of CO₂ in the gas. When using a reactive liquid, the technology may be referred to as a “solid with infused reactive liquid” (SWIRL) that may be useful in low-energy, liquid-based reactions and separations.

Some criteria for generating a SWIRL system include using a solid with an appropriate surface chemistry, an appropriate roughness (also referred to herein as texture), and a high surface area-to-volume contact ratio (A/V) continuum geometry. These criteria allow the reactive liquid to spread within the texture on the solid and provide a high surface area between the fluid medium and the reactive liquid for reaction and separation applications.

### SUMMARY

A nonlimiting method of the present disclosure comprises: providing a liquid reservoir containing a reactive liquid, wherein the liquid reservoir has reservoir features, and wherein the liquid reservoir at the reservoir features has a reservoir capillary pressure (P_{RC}); providing a solid substrate, which has a surface area of greater than 0.001 m²/g, wherein the solid substrate comprises at least two primary structures that have primary features, and wherein the at least two primary structures have at least one primary space therebetween, and wherein the at least two primary structures have a space capillary pressure (P_{SC}) therebetween; and contacting the solid substrate with the reservoir features of the liquid reservoir, thereby impregnating the solid substrate with the reactive liquid, wherein an impregnation capillary pressure (P_{IC}) is formed by the solid substrate and the reactive liquid, and wherein the reservoir features, the primary features, and the at least one primary space are all sized such that P_{SC}<P_{RC}<P_{IC}.

A nonlimiting system of the present disclosure comprises: a solid substrate contained within the reaction chamber, wherein the solid substrate has a surface area of greater than 0.001 m²/g, wherein the solid substrate comprises at least two primary structures that have primary features, wherein the at least two primary structures have at least one primary space therebetween, and wherein the at least two primary structures have a space capillary pressure (P_{SC}) therebetween; a liquid reservoir containing a reactive liquid, wherein the liquid reservoir has reservoir features; and wherein the liquid reservoir at the reservoir features has a reservoir capillary pressure (P_{RC}); wherein the solid substrate is in contact with the reservoir features of the liquid reservoir, wherein an impregnation capillary pressure (P_{IC}) is formed by the solid substrate and the reactive liquid; and wherein the reservoir features, the primary features, and the at least one primary space are all sized such that P_{SC}<P_{RC}<P_{IC}, thereby impregnating the solid substrate with the reactive fluid.

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 illustrates an embodiment comprising solid substrate and liquid reservoir utilizing a traditional liquid impregnation approach.

FIG. 2 illustrates an embodiment comprising solid substrate and liquid reservoir utilizing competitive capillary pressure.

FIG. 3 illustrates a reaction chamber with a solid substrate.

FIG. 4A illustrates an example solid substrate of the present disclosure where the primary structures have a bundled configuration (top view).

FIG. 4B illustrates an example solid substrate of the present disclosure where the primary structures have a bundled configuration (side view).

FIG. 5 illustrates an example solid substrate of the present disclosure where the primary structures have a stacked configuration (planar view).

FIG. 6A illustrates an example solid substrate of the present disclosure where the primary structures have a monolith configuration (top view).

FIG. 6B illustrates an example solid substrate of the present disclosure where the primary structures have a monolith configuration (side view).

FIG. 7 illustrates an enlarged image of a fiber material used as a reservoir.

FIG. 8A illustrates a fiber impregnation setup configuration for a “traditional” method.

FIG. 8B illustrates fibers impregnated using a “traditional” method.

FIG. 9A illustrates a fiber impregnation setup configuration for the competitive capillary pressure method.

FIG. 9B illustrates fibers impregnated using the competitive capillary pressure method.

FIG. 10A illustrates a fluorescent microscopy image of a ceramic monolith impregnated using a “traditional” method.

FIG. 10B illustrates a fluorescent microscopy image of a ceramic monolith impregnated using the competitive capillary pressure method.

### DETAILED DESCRIPTION

The present disclosure relates to methods and related systems for reactor operation utilizing a SWIRL. More specifically, the present disclosure relates to methods and systems for impregnating the solid substrates of the SWIRL. When solid substrates are positioned close together during the impregnating process, liquid can span the space between adjacent solid substrates forming a capillary bridge. The capillary bridge prevents or limits effective flow of a working fluid between the liquid impregnated substrates when the SWIRL is being operated, which, for example, reduces the efficacy of the separation, extraction, and/or enzyme immobilization operation being performed with the SWIRL. Accordingly, additional steps are often taken during the step of impregnating the solid substrate with the reactive liquid to eliminate or reduce the formation of capillary bridges. These additional steps can be costly and time consuming.

The present disclosure describes a reaction system and methods that use competitive capillary pressure during the impregnation of the solid substrate with the reactive liquid to mitigate the formation of capillary bridges between portions of the solid substrate. More specifically, the fluid reservoir used in the impregnation process is designed to have a reservoir capillary pressure that is greater than the capillary pressure of the spaces between the adjacent solid substrates where unwanted capillary bridging may occur. Further, the reservoir capillary pressure is less than the capillary pressure created by the features of the individual solid substrates, which allows the reactive fluid to be driven to impregnate the solid substrates. As a result, the majority of the reactive liquid impregnates the solid substrate with minimal bridging of the reactive liquid between surfaces of the solid substrate.

The impregnation of the reactive liquid on the solid substrate may be any percentage of the surface area of the solid substrate being covered by a layer (or multiple layers) of reactive liquid. This includes from about 0.1% to about 100% (or 1% to 100%, or 5% to 100%, or 10% to 100%, or 50% to 100%, or 1% to 99%, or 5% to 99%, or 10% to 99%, or 50% to 99%) of the surface area of the solid substrate being covered by a layer (or multiple layers) of the reactive liquid.

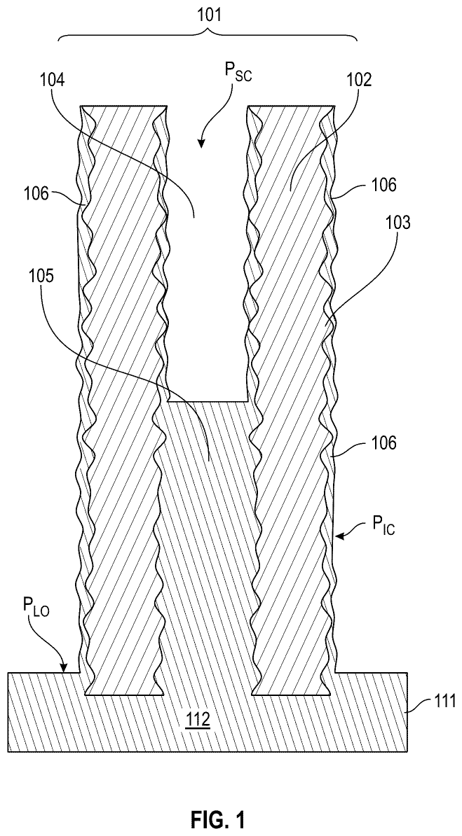

An exemplary conventional system wherein capillary bridges form is illustrated in FIG. 1. A solid substrate 101 having at least two primary structures 102 with primary features 103 is in contact with a liquid reservoir 111 containing a reactive liquid 112. The at least two primary structures 102 have a primary space 104 therebetween. The primary space 104 has a space capillary pressure (P_{SC}) therebetween. The primary features 103 on the primary structures 102 have associated therewith an impregnation capillary pressure (P_{IC}). The liquid reservoir 111 also has a liquid-only capillary pressure (P_{LO}). The sizes of the primary space 104 and the primary features 103, as well as the configuration of the reservoir in this example, are all such that P_{LO}<P_{SC}<P_{IC}, thus leading to the formation of a capillary bridge(s) 105. That is, when the primary structures 102 are in contact with the reactive liquid 112, the reactive liquid 112 will migrate onto the primary structures 102 creating an impregnation layer 106 of the reactive liquid 112 on the surface of the primary structures 102. However, where P_{LO}<P_{SC}<P_{IC} is true, the reactive liquid 112 can also form capillary bridges 105 between the primary structures 102. The capillary bridges 105 block fluid flow between the primary structures 102 when the solid substrates 102 is utilized in SWIRL methods and systems, and the capillary bridges 105 block fluid from interacting with portions of the surface of the impregnation layer 106.

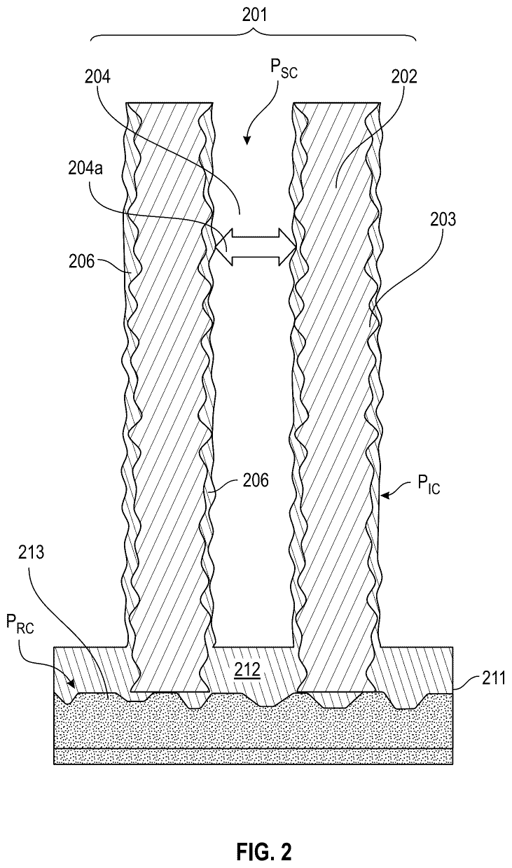

A nonlimiting embodiment of the present disclosure illustrating the use of a competitive capillary pressure approach is shown in FIG. 2. The solid substrate 201 may comprise at least two primary structures 202 that have primary features 203. The at least two primary structures 202 may have at least one primary space 204 therebetween with average width 204a (illustrated by a double-sided arrow) and having a space capillary pressure (P_{SC}) associated therewith. The at least two primary structures 202 may be in contact with a liquid reservoir 211 containing a reactive liquid 212. The liquid reservoir 211 may have reservoir features 213 and a reservoir capillary pressure (P_{RC}) associated therewith. The primary features 203 contribute the primary structures 202 to have an impregnation capillary pressure (P_{IC}) associated therewith. The reservoir features 213, the primary features 203, and the at least one primary space 204 may all be sized such that P_{SC}<P_{RC}<P_{IC}. Therefore, when the primary structures 202 are in contact with the reservoir features 213 and the reactive liquid 212, the reactive liquid 212 will migrate up the primary structures 202 creating an impregnation layer 206 of the reactive liquid 212 on the surface of the primary structures 202. Further, where P_{SC}<P_{RC}<P_{IC} is true, the formation of capillary bridges is mitigated or, possibly, eliminated. Thus, the impregnation layer 206 has greater surface area that is not obstructed by capillary bridges.

The size, shape, and/or arrangement of (i) the reservoir features, (ii) the primary features of the solid substrates, and (iii) the primary space(s) may be used to achieve the P_{SC}<P_{RC} <P_{IC}. For example, the primary features (e.g., pores of a foamed primary structure) having a smaller size than the width between the primary structure provide for P_{SC}<P_{IC}. Further, the reservoir features (e.g., space between fibers of a nonwoven fabric) having a smaller size than the width between the primary structure provide for P_{SC}<P_{RC}. Finally, the primary features of the primary structures having a smaller size than the reservoir features provide for P_{RC}<P_{IC}. Other configurations of (i) the reservoir features, (ii) the primary features of the solid substrates, and (iii) the primary space(s) may be used to achieve the P_{SC}<P_{RC} <P_{IC}. The reservoir features, the primary features of the solid substrates, and the primary spaces are discussed in more detail herein.

Furthermore, the present disclosure provides a method of utilizing a SWIRL system. In certain embodiments, the method may include: providing a liquid reservoir containing a reactive liquid, providing a solid substrate with at least two primary structures that may have at least one primary space therebetween, wherein the reservoir features, the primary features, and the at least one primary space are all sized such that P_{SC}<P_{RC}<P_{IC}, and contacting the solid substrate with the reservoir features of the liquid reservoir, thereby impregnating the solid substrate with the reactive liquid.

Impregnation of solid substrates described herein with reactive liquids and applications and systems thereof are discussed in more detail in US Patent App. Pub. Nos. 2020/0147543, 2020/0147545, and 2020/0147519, which are incorporated herein by reference.

The reactive liquid may impregnate at least 20% (or at least 30%, or at least 40%, or at least 50%, or at least 60%, or at least 70%, or 20% to 100%, or 30% to 100%, or 40% to 100%, or 50% to 100%, or 60% to 100%, or 70% to 100%, or 20% to 60%, or 30% to 60%, or 40% to 60%) of the surface area of the solid substrate after the impregnating of the solid substrate with the reactive liquid.

About 30 vol % or less (or about 20 vol % or less, or about 10 vol % or less, or about 5 vol % or less, or about 0 vol %, or 0 vol %, or 1 vol % to 30 vol %, or 1 vol % to 20 vol %, or 1 vol % to 10 vol %, or 5 vol % to 15 vol %, or 30 vol % to 0 vol %) of the at least one primary space may contain the reactive liquid after the impregnation of the solid substrate with the reactive liquid.

The contacting of the solid substrate with the reservoir features of the liquid reservoir may occur for about 1 minute to about 7 days (or about 1 minute to about 5 days, or about 1 minute to about 3 days, or about 1 minute to about 1 day, or about 1 day to about 5 days, or about 1 day to about 3 days, or about 1 minute to about 20 hours, or about 1 minute to about 10 hours, or about 1 minute to about 5 hours, or about 1 minute to about 90 minutes, or about 1 minute to about 60 minutes, or about 5 minutes to about 60 minutes, or about 30 minutes to about 60 minutes, or about 60 minutes to about 90 minutes).

The reactive liquid may have a contact angle with the at least two primary structures in the presence of the working fluid. The reactive liquid may have a contact angle on the solid substrate in the presence of the working fluid that is less than about 90 degrees (or less than about 80 degrees, or less than about 70 degrees, or less than about 65 degrees, or less than about 50 degrees, or less than about 45 degrees, or less than about 30 degrees, or less than about 20 degrees, or less than about 18 degrees, or less than about 15 degrees, or less than about 12 degrees, or less than about 10 degrees, or less than about 8 degrees, or less than about 6 degrees, or less than about 5 degrees, or less than about 4 degrees, or less than about 3 degrees, or less than about 2 degrees, or less than about 1 degree, or about 0 degrees, or 0 degrees). The contact angle quantifies the wettability of the solid substrate and can be measured using a contact angle apparatus such as a static sessile drop measurement device. The contact angle can be measured for the reactive liquid and primary structure in the presence of the working fluid.

Impregnation of the solid substrate with the reactive liquid may occur while the solid substrate is outside the SWIRL system (e.g., not contained within a reaction chamber) or while the solid substrate is at least partially contained within the SWIRL system. For example, the solid substrate may be impregnated with the reactive liquid and then placed in the SWIRL system (e.g., in the reaction chamber). Alternatively, the solid substrate may be at least partially contained within the reaction chamber before the contacting of the solid substrate with the reservoir features of the liquid reservoir. For example, the reaction chamber may have a portion (e.g., a door) that allows the solid substrate to be accessed and brought into contact with the fluid reservoir, the reservoir features, and the reactive fluid. Once the solid substrate is impregnated to the desired degree, the fluid reservoir may be removed and the portion of the chamber replaced.

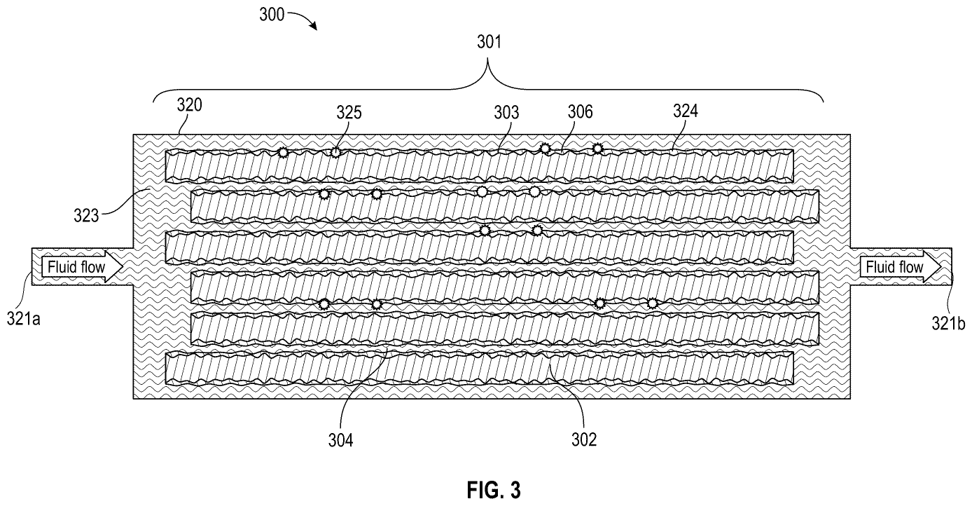

FIG. 3 illustrates a nonlimiting example SWIRL system 300. A solid substrate 301 having an impregnation layer 306 of reactive liquid may be contained within a reaction chamber 320. The reaction chamber may comprise a working fluid inlet 321a and a working fluid outlet 321b. The solid substrate 301 may comprise at least two primary structures 302, wherein the primary structures 302 may have primary features 303 and may have at least one primary space 304 therebetween. The at least one primary space 304 may allow a working fluid 323 to flow through the reaction chamber 320 and contact the impregnation layer 306 on the solid substrate 301 such that a liquid-fluid interface 324 is produced. The method may further comprise extracting at least one substance 325 from the working fluid 323 to the impregnation layer 306 of reactive liquid as a result of mass transfer across the liquid-fluid interface 324.

The working fluid inlet and working fluid outlet may allow for fluids other than the working fluid to flow between the primary structures. Fluids other than the working fluid may flow between the primary structures alone or in a combination which may include the working fluid. The flowing of fluids other than the working fluid between the primary structures may occur for purposes including regenerating the reactive liquid and absorbing substances (e.g., at least one substance 325 of FIG. 3) from the reactive liquid. Additionally, the working fluid (or any other fluid flowing between the working fluid inlet and the working fluid outlet) may flow in any direction (e.g. from the working fluid inlet to the working fluid outlet, from the working fluid outlet to the working fluid inlet, or any combinatory flow sequence thereof).

### Liquid Reservoir

The liquid reservoir of the present disclosure may include reservoir features and be capable of containing the reactive liquid for impregnating the solid substrate.

The material composition, shape, structure (or material configuration), and spacing of the reservoir features effect the reservoir capillary pressure (P_{RC}).

The reservoir features may be comprised of any suitable material including, but not limited to, metal oxides (e.g., glass, quartz, silica, alumina, titania, and the like), metals (e.g., stainless steel, copper, iron, and the like), polymers (polyethylene, polypropylene, polystyrene, polyamides, polyurethanes, cellulosic polymers, and the like), the like, and any combination thereof. The material should be non-reactive with the reactive liquid.

The reservoir features may have any suitable shape including, but not limited to, particles, fibers, pillars, indentations, pores, the like, and any combination thereof.

Examples material configurations that may be used to create the reservoir features may include, but are not limited to, a mesh, fibers (e.g., woven fabrics and/or nonwoven fabrics), 3-dimensionally printed structures, foams, the like, and any combination thereof.

The reservoir features may have an average spacing of about 1 μm to about 500 μm (or about 1 μm to about 200 μm, or about 1 μm to about 100 μm, or about 1 μm to about 50 μm, or about 20 μm to about 100 μm).

### Solid Substrate

As described above, the solid substrate of the present disclosure comprises primary structures. Said primary structures may include primary features (e.g., pores or roughness) and optionally a chemical functionalization.

The primary structures may be arranged in any suitable configuration that supports impregnation of the primary structures with the reactive liquid including, but not limited to, a spiral conformation, a stacked conformation, a bundled conformation, a monolith structure, a piled conformation, the like, and any combination thereof.

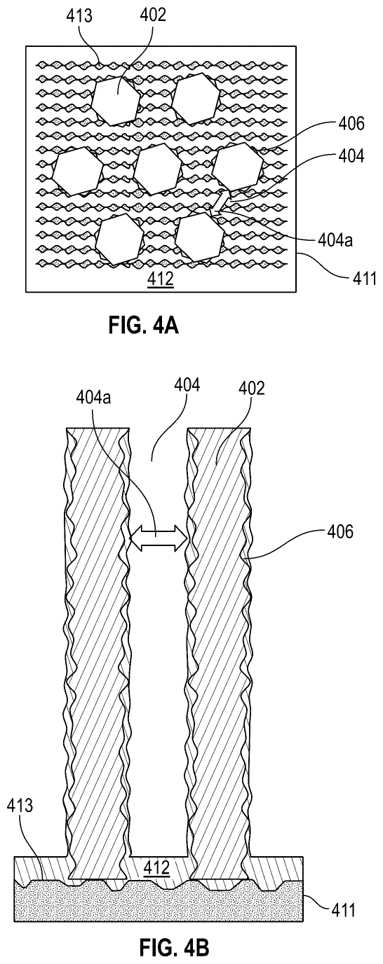

FIGS. 4A and 4B illustrate a top view and a side view, respectively, of an example solid substrate of the present disclosure where the primary structures 402 have a bundled configuration. FIG. 4A illustrates a top view of seven cylindrical primary structures in a bundled configuration contacting reservoir features 413 of a reservoir 411 with reactive liquid 412. An impregnation layer 406 of reactive liquid 412 can be found on the primary structures 402. FIG. 4B illustrates a side view of two of the cylindrical primary structures 402 of the bundled configuration. Also shown in FIGS. 4A and 4B is the primary space 404 between the cylindrical primary structures 402 and an average width 404a (illustrated by a double-sided arrow) of the primary space 404.

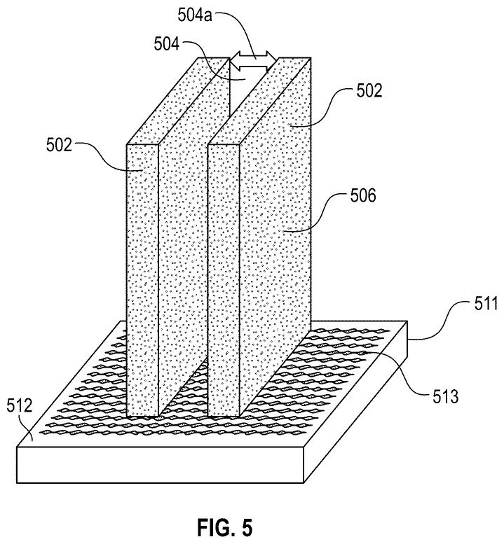

FIG. 5 illustrates a planar view of an example solid substrate of the present disclosure where the primary structures 502 have a stacked configuration contacting reservoir features 513 of a reservoir 511 with reactive liquid 512. An impregnation layer 506 of reactive liquid 512 can be found on the primary structures 502. FIG. 5 illustrates a stacked configuration of at least two primary structures 502 with at least one primary space 504 therebetween, having an average width 504a (illustrated by a double-sided arrow).

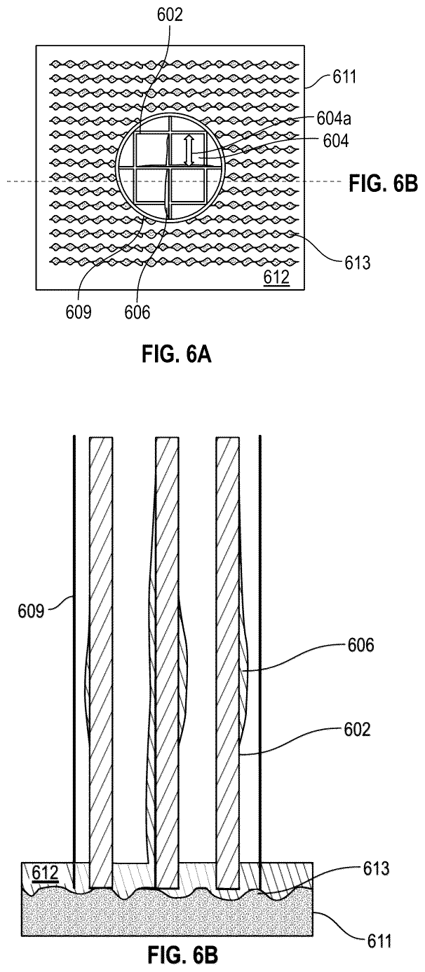

FIGS. 6A and 6B illustrate a top view and a side view, respectively, of an example solid substrate of the present disclosure where the primary structures have a monolith structure 609. FIG. 6A illustrates a monolith structure 609 comprising at least two primary structures 602 clustered within the monolith structure 609. The individual primary structures 602 comprise at least one primary space 604 therebetween, having an average width 604a (illustrated by a double-sided arrow). The monolith structure 609 may be in contact with reservoir features 613 of a reservoir 611 with reactive liquid 612. The reactive liquid may impregnate the primary structures 602, forming an impregnation layer 606 of the reactive liquid 612. FIG. 6A shows a dashed line illustrating the plane in which the side view of FIG. 6B is shown. FIG. 6B illustrates a side view of a monolith structure 609 showing the at least two primary structures 602 with impregnation layer 606 thereupon. Examples of monolith structures may include, but are not limited to, ceramic honeycombs with holes that are of any suitable cross-sectional shape like circle, square, triangle, hexagon, and the like. Another example of a monolith structure may include, but is not limited to, a laves phase structure in a hexagonal, cubic, or other configuration.

The material composition, structure (or material configuration), and chemical functionalization of the primary structures and the shape and spacing of the primary features effect the impregnation capillary pressure (P_{IC}). The foregoing and the distance between the primary structures may affect the space capillary pressure (P_{SC}).

The primary structures may be comprised of any suitable material including, but not limited to, metal oxides (e.g., glass, quartz, silica, alumina, titania, and the like), metals (e.g., stainless steel, copper, iron, and the like), polymers (polyethylene, polypropylene, polystyrene, polyamides, polyurethanes, cellulosic polymers, and the like), the like, and any combination thereof. The material should be non-reactive with the reactive liquid. A nonlimiting example primary structure may comprise a hexagonal laves phase material such as MgZn₂ or MgNi₂.

Examples of material configuration for the primary structures may include, but are not limited to, a nonporous structure, a foam, fibers, a mesh, the like, and any combination thereof. The material configuration (e.g., a foam, fibers, or a mesh) may provide at least some of the primary features on the primary structures. Foam, as used herein, refers to a solid and porous structure.

The solid substrate may comprise at least two primary structures. The at least two primary structures may form at least one primary space therebetween. The primary spaces may have an average width (distance between adjacent primary structures) from about 1 μm to about 1000 μm (or about 50 μm to about 1000 μm, or about 1 μm to about 500 μm, or about 10 μm to about 500 μm, or about 100 μm to about 500 μm, or about 10 μm to about 400 μm, or about 50 μm to about 300 μm, or about 100 μm to about 250 μm, or about 200 μm to about 500 μm, or about 300 μm to about 500 μm, or about 400 μm to about 500 μm). Within a single solid substrate may have primary structures spaced at different average widths. For example, a first primary structure may be about 25 μm from a second primary structure that is adjacent to the first primary structure and may be about 50 μm from a third primary structure that is also adjacent to the first primary structure.

The primary structures may comprise a rough surface, a textured surface, a porous surface, or a combination thereof, which may provide at least some of the primary features on the primary structures.

The primary features of the primary structures may be of any suitable form including, but not limited to, particles, pillars, elongated solid features, indentations, pores, the like, and any combination thereof.

The primary features may have an average size (e.g., extent of protrusion from the primary structure, depth of depression into the primary structure, or pore size) of about 0.1 μm to about 1000 μm (or 0.1 μm to 500 μm, or 1 μm to 500 μm, or 1 μm to 250 μm, or 1 μm to 100 μm, or 100 μm to 500 μm). Further, the primary features may be spaced apart by about 0.1 μm to about 500 μm (or 0.1 μm to 500 μm, or 1 μm to 500 μm, or 1 μm to 250 μm, or 1 μm to 100 μm, or 100 μm to 500 μm).

The solid substrates may have a surface area of greater than 0.001 m²/g (or about 0.001 m²/g to about 45 m²/g, or about 0.001 m²/g to about 20 m²/g, or about 0.01 m²/g to about 45 m²/g, or about 0.1 m²/g to about 45 m²/g, or about 1 m²/g to about 45 m²/g).

The solid substrate may have a surface area to volume ratio (A/V) greater than 180 m⁻¹, greater than 500 m⁻¹, or greater than 1000 m⁻¹ (or 180 m⁻¹ to 1000 m⁻¹, or 500 m⁻¹ to 2000 m⁻¹, or 1000 m⁻¹ to 5000 m⁻¹, or 1000 m⁻¹ to 50000 m⁻¹). For purposes of calculation, surface area, A, is the apparent surface area provided by the external-facing surface areas of the primary structures of the solid substrate including any openings therein. However, given that it is difficult to account for micro-scale surface roughness, the calculation of A presumes that external-facing surfaces are smooth. For example, the calculation of A includes the additional surface area provided by the primary features, but presumes for simplicity that the surfaces of the walls making up the primary features are smooth. The system volume, V, is defined as the geometric volume of the solid substrate based only on the dimensions of the external surfaces, and presuming those surfaces are smooth. In other words, V is calculated in a simplified manner that presumes a solid substrate defined by its external surfaces, with no micro-textures on those external surfaces. These calculations can be performed by a software program such as nTopology Element or Autodesk NetFabb.

The solid substrate may have a performance index (PI) of greater than 150 m⁻¹ (or greater than 500 m⁻¹, or 150 m⁻¹ to 1000 m⁻¹, or 150 m⁻¹ to 2000 m⁻¹, or 500 m⁻¹ to 1000 m⁻¹, or 500 m⁻¹ to 2000 m⁻¹, or 500 m⁻¹ to 5000 m⁻¹). PI is defined as PI=(Vl/V)(Al/V). Vl and Al are the volume and surface area of the reactive liquid, respectively. Vl may be determined by weighing the apparatus before and after applying the reactive liquid, and then converting the mass difference (e.g., the mass of reactive liquid held by the apparatus) into a volume using the density of the reactive liquid. Systems with a PI greater than 150 m⁻¹ are more efficient, and thus can be smaller and less expensive than conventional systems.

The surface of the solid substrates may have an appropriate solid surface functionalization that may include chemical functionalization. The solid surface functionalization, in addition to the primary features of the primary structures, may facilitate the formation and retention of the impregnation layer of the reactive liquid on the surface of the solid substrates. The reactive liquid covering the surface of the solid substrates keeps its liquid nature. The liquid nature of the reactive liquid may be used as the medium for separation, extraction, and/or enzyme immobilization in SWIRL methods and systems. For example, the reactive liquid may be able to infuse into the features on the surface or encapsulate the entire surface of the solid substrates because the liquid's chemistry allows the liquid to substantially spread onto the solid fully. The spreading is measured using the liquid contact angle on the solid.

### Reactive Liquid

The reactive liquid may interact with a working fluid to create a liquid-fluid interface. Across the liquid-fluid interface, mass transfer may occur to effect the separation, extraction, and/or enzyme immobilization. For example, contaminants in the working fluid may be absorbed by the reactive fluid at the liquid-fluid interface. In another example, a component of the working fluid may be extracted from the reacted fluid at the liquid-fluid interface.

Examples of reactive liquids may include, but are not limited to, an amine, monoethanolamine, tetraethylpentamine (TEPA), monoethanolamine (MEA), diethanolamine (DEA), and triethanolamine (TEA), dimethylaminoethanol (DMAE), 2-(methylamino)-2-methyl-1-propanol (MAMP), 2-amino-2-methyl-1-propanol (AMP), 2-piperidine methanol, 2-piperidine ethanol, 2-amino-2-methyl-1-propanol, 2-amino-2-methyl-1-butanol, 3-amino-3-methyl-2-pentanol, 3-amino-3-methyl-1-butanol, 2-piperidine alkanol, an alkali metal hydroxide, potassium hydroxide, sodium hydroxide, lithium hydroxide, glycol, triethylene glycol, an enzyme, a potassium compound, toluene, the like, and any combination thereof.

### Working Fluid

The working fluid may interact with the reactive liquid in order to facilitate mass transfer across a liquid-fluid interface. In some embodiments the reactive liquid and the working fluid may be immiscible. The working fluid may be a liquid or may be a gas.

Examples of working fluids may include, but are not limited to, an aqueous solution, an organic solution, flue gas, carbon dioxide, water, furfural, air, the like, and any combination thereof.

### ADDITIONAL EMBODIMENTS

Embodiment 1. A method comprising: providing a liquid reservoir containing a reactive liquid, wherein the liquid reservoir has reservoir features, and wherein the liquid reservoir at the reservoir features has a reservoir capillary pressure (P_{RC}); providing a solid substrate, which has a surface area of greater than 0.001 m²/g, wherein the solid substrate comprises at least two primary structures that have primary features, and wherein the at least two primary structures have at least one primary space therebetween, and wherein the at least two primary structures have a space capillary pressure (P_{SC}) therebetween; and contacting the solid substrate with the reservoir features of the liquid reservoir, thereby impregnating the solid substrate with the reactive liquid, wherein an impregnation capillary pressure (P_{IC}) is formed by the solid substrate and the reactive liquid, and wherein the reservoir features, the primary features, and the at least one primary space are all sized such that P_{SC}<P_{RC}<P_{IC}.

Embodiment 2. The method of Embodiment 1 further comprising: containing the solid substrate to a reaction chamber comprising a working fluid inlet and a working fluid outlet; contacting a working fluid with the reactive liquid impregnated on the solid substrate, thereby creating a liquid-fluid interface; and extracting at least one substance from the working fluid to the reactive liquid via mass transfer across the liquid-fluid interface.

Embodiment 3. The method of Embodiment 2 further comprising: after the contacting of the solid substrate with the reservoir features of the liquid reservoir, placing the solid substrate in the reaction chamber so as to contain the solid substrate in the reaction chamber.

Embodiment 4. The method of Embodiment 2 or 3, wherein the solid substrate is at least partially contained within the reaction chamber before the contacting of the solid substrate with the reservoir features of the liquid reservoir.

Embodiment 5. The method of any one of Embodiments 1-4, wherein the solid substrate has a performance index (PI) of least 150 m⁻¹.

Embodiment 6. The method of any one of Embodiments 1-5, wherein the reactive liquid impregnates at least 30% of the surface area of the solid substrate after the impregnation of the solid substrate with the reactive liquid.

Embodiment 7. The method of any one of Embodiments 1-6, wherein about 30 vol % or less of the at least one primary space contains the reactive liquid after the impregnation of the solid substrate with the reactive liquid.

Embodiment 8. The method of any one of Embodiments 1-7, wherein the contacting of the solid substrate with the reservoir features of the liquid reservoir occurs for about 1 minute to about 3 days.

Embodiment 9. The method of any one of Embodiments 1-8, wherein the solid substrate has an A/V greater than 180 m⁻¹, wherein A is the surface area of the solid substrate and V is a volume of the solid substrate.

Embodiment 10. The method of any one of Embodiments 1-9, wherein the primary features have an average size of about 0.1 μm to about 1000 μm.

Embodiment 11. The method of any one of Embodiments 1-10, wherein the primary features are spaced apart by about 0.1 μm to about 500 μm.

Embodiment 12. The method of any one of Embodiments 1-11, wherein the reservoir features are spaced apart by an average distance of about 1 μm to about 500 μm.

Embodiment 13. The method of any one of Embodiments 1-12, wherein the at least one primary space has an average width of about 1 μm to about 100 μm.

Embodiment 14. The method of any one of Embodiments 1-13, wherein the reactive liquid has a contact angle with the at least two primary structures in the presence of the working fluid that is less than about 90 degrees.

Embodiment 15. The method of any one of Embodiments 1-14, wherein the working fluid comprises: carbon dioxide, flue gas, water, furfural, air, or any combination thereof.

Embodiment 16. The method of any one of Embodiments 1-15, wherein the reactive liquid comprises: an amine, an alkali metal hydroxide, a potassium compound, toluene, glycol, an enzyme, or any combination thereof.

Embodiment 17. The method of any one of Embodiments 1-16, wherein the at least two primary structures have a material configuration conformation comprising: a nonporous structure, a foam, a plurality of fibers, a mesh, or any combination thereof.

Embodiment 18. The method of any one of Embodiments 1-17, wherein the at least two primary structures have a material composition comprising: a metal oxide, a metal, a polymer, or any combination thereof.

Embodiment 19. A system comprising: a solid substrate contained within a reaction chamber, wherein the solid substrate has a surface area of greater than 0.001 m²/g, wherein the solid substrate comprises at least two primary structures that have primary features, wherein the at least two primary structures have at least one primary space therebetween, and wherein the at least two primary structures have a space capillary pressure (P_{SC}) therebetween; a liquid reservoir containing a reactive liquid, wherein the liquid reservoir has reservoir features, and wherein the liquid reservoir at the reservoir features has a reservoir capillary pressure (P_{RC}); wherein the solid substrate is in contact with the reservoir features of the liquid reservoir, wherein an impregnation capillary pressure (P_{IC}) is formed by the solid substrate and the reactive liquid; and wherein the reservoir features, the primary features, and the at least one primary space are all sized such that P_{SC}<P_{RC}<P_{IC}, thereby impregnating the solid substrate with the reactive liquid.

Embodiment 20. The system of Embodiment 19, wherein the primary features have an average size of about 0.1 μm to about 1000 μm.

Embodiment 21. The system of Embodiment 19 or 20, wherein the primary features are spaced apart by about 0.1 μm to about 500 μm.

Embodiment 22. The system of any one of Embodiments 19-21, wherein the reservoir features are spaced apart by an average distance of about 1 μm to about 500 μm.

Embodiment 23. The system of any one of Embodiments 19-22, wherein the at least one primary space has an average width of about 1 μm to about 100 μm.

Embodiment 24. The system of any one of Embodiments 19-23, wherein the at least two primary structures further comprises a rough surface, a textured surface, or both.

Embodiment 25. The system of any one of Embodiments 19-24, wherein the at least two primary structures have an arrangement in a spiral conformation; and/or a stacked conformation; and/or a bundled conformation; and/or a monolith structure.

Embodiment 26. The system of any one of Embodiments 19-25, wherein the at least two primary structures have a material configuration conformation comprising: a nonporous structure, a foam, a plurality of fibers, a mesh, or any combination thereof.

Embodiment 27. The system of any one of Embodiments 19-26, wherein the at least two primary structures have a material composition which comprises: a metal oxide, a metal, a polymer, or any combination thereof.

Embodiment 28. The system of any one of Embodiments 19-27, further comprising an S/V of greater than 150 m⁻¹, wherein S is the surface area of the solid substrate and V is a volume of the solid substrate.

Embodiment 29. The system of any one of Embodiments 19-28, wherein the system has a performance index, PI, of at least 150 m⁻¹.

Embodiment 30. The system of any one of Embodiments 19-29, wherein the reactive liquid impregnates at least 30% of the surface area of the solid substrate.

Embodiment 31. The system of any one of Embodiments 19-30, wherein about 30 vol % or less of the at least one primary space contains the reactive liquid.

Embodiment 32. The system of any one of Embodiments 19-31, wherein the reactive liquid comprises at least one of: an amine, an alkali metal hydroxide, a potassium compound, toluene, glycol, or an enzyme.

Embodiment 33. The system of any one of Embodiments 19-32, wherein the solid substrate is contained within a reaction chamber comprising a working fluid inlet and a working fluid outlet.

Embodiment 34. The system of any one of Embodiments 19-33, further comprising a working fluid forming a liquid-fluid interface with the reactive liquid.

Embodiment 35. The system of Embodiment 34, wherein the reactive liquid facilitates mass transfer of at least one substance across the liquid-fluid interface.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### EXAMPLES

### Example 1

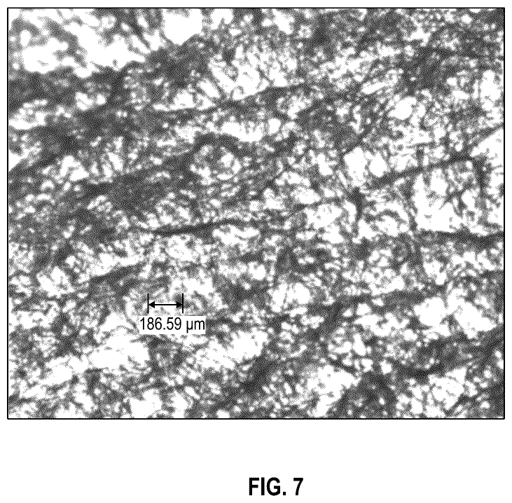

An additively manufactured substrate comprising a bundle of parallel, rough fibers is contacted at one end with a reservoir of a liquid. The fibers and the spacing between the fibers is on the order of a hundred micrometers. A visualization of the rough surface of the fibers is visible in FIG. 7. A thin sheath of liquid is drawn onto the fibers, impregnating the fibers.

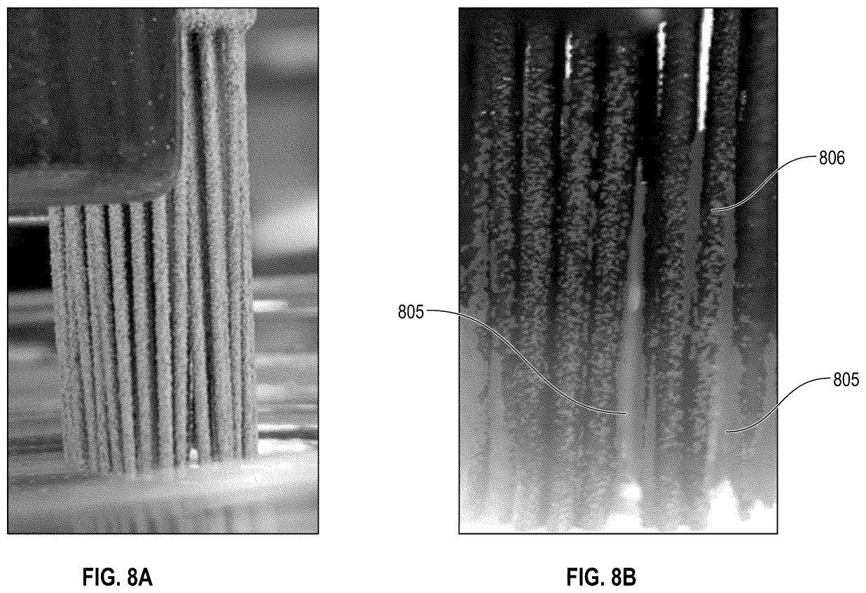

A traditional impregnation was prepared, as illustrated in FIG. 8A. The edge of the fibers is contacted with a reservoir of liquid. The fibers are impregnated with the liquid, including capillary bridges therebetween. FIG. 8B illustrates the liquid impregnation layer 806 on the fibers with capillary bridges 805 forming therebetween.

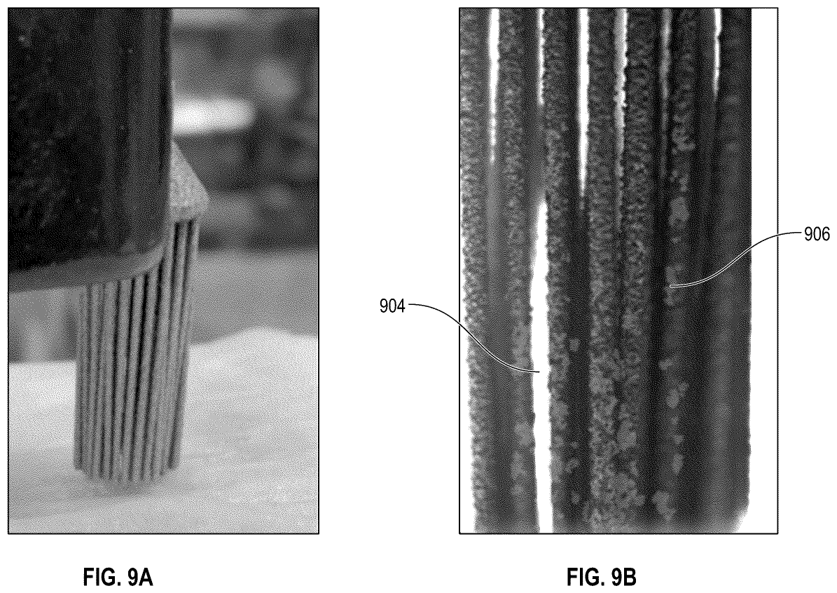

Utilizing a competitive capillary approach, as illustrated in FIG. 9A the liquid was first introduced to a paper filter (KIMWIPE™, available from Kimberly-Clark), and then the fibers were contacted with the paper filter with pores between the fibers which were greater than the pores of the fibers but smaller than the spaces between the fibers. The liquid was impregnated onto the fibers without forming capillary bridges. FIG. 9B illustrates the liquid impregnation layer 906 on the fibers with no capillary bridges forming in the primary space 904 therebetween (no dark liquid in the spaces between the fibers).

### Example 2

A ceramic monolith configuration is utilized to compare “traditional” approaches of impregnation with the competitive capillary pressure method and system described in the present disclosure.

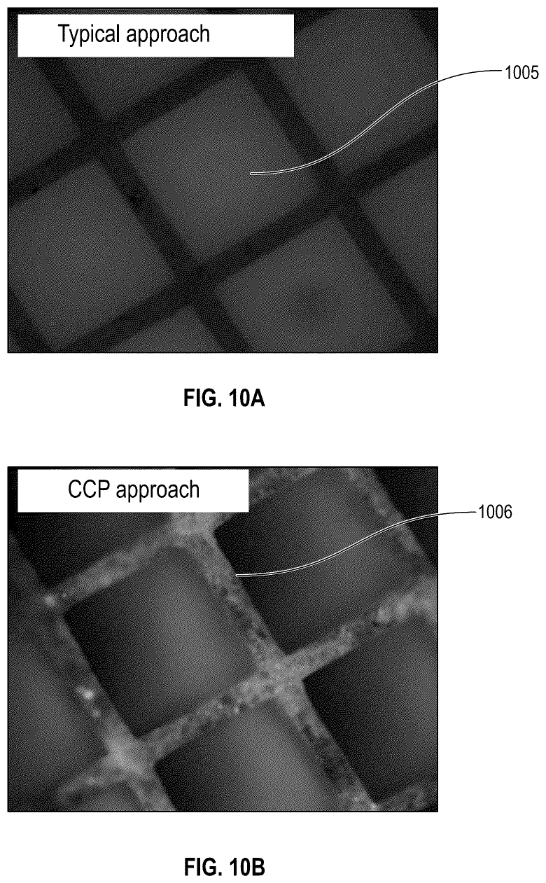

A ceramic monolith with a square cross-section pore geometry of approximately 635 μm by 635 μm was plasma cleaned for 2 minutes in a Harrick PDC-32G plasma cleaner set to “High” RF level. The plasma treatment increased its surface energy to make it highly wettable and able to be impregnated. To visualize the presence of the liquid, water with fluorescent dye was used. Following the traditional approach to impregnate a monolith, the liquid was introduced to the ceramic monolith by slightly immersing the edge of the monolith into a reservoir of the liquid. The capillary action pulled the liquid into every channel and flooded all of the previously open pores of the monolith, significantly reducing liquid surface area. A fluorescence microscopy image of this flooding and the capillary bridges 1005 formed upon utilizing the “traditional” is visible in FIG. 10A. In FIG. 10A, capillary bridges 1005 form in the square-shaped channels of the ceramic monolith, as indicated by light shading, due to fluorescence of the liquid, throughout the square-shaped channels.

To avoid liquid flooding and bridging within the channels the competitive capillary pressure method was used to impregnate a separate plasma-treated monolith. The liquid was first introduced to a paper filter (KIMWIPE™, available from Kimberly-Clark) reservoir with porosity larger than the roughness of the moonlight wall surface and smaller than the distance between the wall channels. The capillary action was able to pull the liquid from the paper filter and spread over the surface of the wall. The capillary pressure within the paper filter did not allow flow of liquid within the channels. This approach significantly enhanced liquid surface area and kept the monolith channels open, as visible in the fluorescence microscopy image in FIG. 10B. In FIG. 10B, the only partial shading of the square-shaped channels indicates impregnation of the walls (in an impregnation layer 1006) of the square-shaped channels and thus mitigation of capillary bridging.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
providing a liquid reservoir containing a reactive liquid, wherein the liquid reservoir has reservoir features, and wherein the liquid reservoir at the reservoir features has a reservoir capillary pressure (P_{RC});
providing a solid substrate, which has a surface area of greater than 0.001 m²/g, wherein the solid substrate comprises at least two primary structures that have primary features, and wherein the at least two primary structures have at least one primary space therebetween, and wherein the at least two primary structures have a space capillary pressure (P_{SC}) therebetween; and
contacting the solid substrate with the reservoir features of the liquid reservoir, thereby impregnating the solid substrate with the reactive liquid,
wherein an impregnation capillary pressure (P_{IC}) is formed by the solid substrate and the reactive liquid, and
wherein the reservoir features, the primary features, and the at least one primary space are all sized such that P_{SC}<P_{RC}<P_{IC}.

2. The method of claim 1 further comprising:
containing the solid substrate to a reaction chamber comprising a working fluid inlet and a working fluid outlet;
contacting a working fluid with the reactive liquid impregnated on the solid substrate, thereby creating a liquid-fluid interface; and
extracting at least one substance from the working fluid to the reactive liquid via mass transfer across the liquid-fluid interface.

3. The method of claim 2 further comprising:
after the contacting of the solid substrate with the reservoir features of the liquid reservoir, placing the solid substrate in the reaction chamber so as to contain the solid substrate in the reaction chamber.

4. The method of claim 2, wherein the solid substrate is at least partially contained within the reaction chamber before the contacting of the solid substrate with the reservoir features of the liquid reservoir.

5. The method of claim 1, wherein about 30 vol % or less of the at least one primary space contains the reactive liquid after the impregnation of the solid substrate with the reactive liquid.

6. The method of claim 1, wherein the contacting of the solid substrate with the reservoir features of the liquid reservoir occurs for about 1 minute to about 3 days.

7. The method of claim 1, wherein the primary features have an average size of about 0.1 μm to about 1000 μm.

8. The method of claim 1, wherein the reservoir features are spaced apart by an average distance of about 1 μm to about 500 μm.

9. The method of claim 1, wherein the at least one primary space has an average width of about 1 μm to about 100 μm.

10. The method of claim 1, wherein the reactive liquid has a contact angle with the at least two primary structures in the presence of a working fluid that is less than about 90 degrees.

11. The method of claim 1, wherein the at least two primary structures have a material configuration conformation comprising: a nonporous structure, a foam, a plurality of fibers, a mesh, or any combination thereof.

12. The method of claim 1, wherein the at least two primary structures have a material composition comprising: a metal oxide, a metal, a polymer, or any combination thereof.

13. A system comprising:
a solid substrate contained within a reaction chamber, wherein the solid substrate has a surface area of greater than 0.001 m²/g, wherein the solid substrate comprises at least two primary structures that have primary features, wherein the at least two primary structures have at least one primary space therebetween, and wherein the at least two primary structures have a space capillary pressure (P_{SC}) therebetween;
a liquid reservoir containing a reactive liquid, wherein the liquid reservoir has reservoir features, and wherein the liquid reservoir at the reservoir features has a reservoir capillary pressure (P_{RC});
wherein the solid substrate is in contact with the reservoir features of the liquid reservoir, wherein an impregnation capillary pressure (P_{IC}) is formed by the solid substrate and the reactive liquid; and
wherein the reservoir features, the primary features, and the at least one primary space are all sized such that P_{SC}<P_{RC}<P_{IC}, thereby impregnating the solid substrate with the reactive liquid.

14. The system of claim 13, wherein the primary features have an average size of about 0.1 μm to about 1000 μm.

15. The system of claim 13, wherein the reservoir features are spaced apart by an average distance of about 1 μm to about 500 μm.

16. The system of claim 13, wherein the at least one primary space has an average width of about 1 μm to about 100 μm.

17. The system of claim 13, wherein the at least two primary structures have an arrangement in
a spiral conformation; and/or
a stacked conformation; and/or
a bundled conformation; and/or
a monolith structure.

18. The system of claim 13, wherein the at least two primary structures have a material configuration conformation comprising: a nonporous structure, a foam, a plurality of fibers, a mesh, or any combination thereof.

19. The system of claim 13, wherein the at least two primary structures have a material composition which comprises: a metal oxide, a metal, a polymer, or any combination thereof.

20. The system of claim 13, wherein about 30 vol % or less of the at least one primary space contains the reactive liquid.
